(19) United States
(12) Patent Application Publication
(10) Pub. No.: US 2003/0094489 A1
(43) Pub. Date: May 22, 2003

(54) Voting system and method

(76) Inventor: Stephanie Wald, Givat Zeev (IL)

Correspondence Address: Welsh & Katz, 120 S Riverside Plaza 22nd Floor, Chicago, IL, 60606-3913, US

(21) Appl. No.: 10/258,293

(22) PCT Filed: Apr. 16, 2001
(86) PCT No.: PCT/IL01/00345

(51) Int. Cl. G06F 17/60

(52) U.S. Cl. 235/386

(57) ABSTRACT

A system and a method for voting with a unique one-time token by an audience member, which is fully automated. The token is preferably usable only within a predetermined lifespan, such that the time period for collecting the data is predefined. If the audience is to be allowed to submit more than one preference, or to have more than one “vote”, preferably a plurality of tokens are provided to the audience member. According to one embodiment, such a plurality of tokens are all preferably of equal weight, or generic. Alternatively, such tokens may optionally and preferably be classified, in which a first token is for voting for a first preference, a second token is for voting for a second preference, and so forth.

### FIELD OF THE INVENTION

The present invention relates to a system and a method for electronic voting.

### BACKGROUND OF THE INVENTION

The determination of the preferences and/or opinions of members of an audience is frequently desired in order to evaluate the popularity of a performance. If the members of the audience are gathered in a central location, such as a theatre for example, then gathering such opinions and/or preferences is relatively easy. For example, paper questionnaires can be distributed to the members of the audience, who would then write or mark answers to various questions on the paper document. This document would then be returned to the theatre personnel, who could use the information contained therein to decide which types of performances should be scheduled, for example. Alternatively or additionally, theatre personnel could ask the members of the audience questions directly about the performance and/or about possible future performances, in order to ascertain the preferences and/or opinions of the audience members. In any case, such polling is clearly simplified by having the members of the audience together at one location.

The situation is clearly more complicated for contacting audience members, or potential audience members, who are scattered at a plurality of locations. For example, viewers of television programs are more difficult to contact, as such television programs are typically watched at the home of the viewer, such that the audience members are scattered over a large number of separate locations. Regardless of the specific location of the television, audience members are not gathered in one central location, as they are for theatre performances, for example. Other examples of devices for displaying media content to a widely scattered audience include, but are not limited to, radio and computational devices connected to the Internet.

Mechanisms which are known in the art for gathering the preferences and/or opinions of members of such scattered audiences include a number of passive polling mechanisms. For example, U.S. Pat. No. 4,972,503 describes a method and apparatus for determining the channel of a plurality of predetermined channels to which a remotely controlled receiver is tuned, in order to identify audience viewing habits. Other mechanisms which are known in the art are also able to determine which television programs are being displayed by a television, or at least to identify the time and channel for the display, which can be used to determine which television programs are of interest to the viewer. However, passive mechanisms have the disadvantage of only being able to determine the television program which is being watched, but cannot actively inquire as to the preferences and/or opinions of the audience members.

Such active inquiry requires active polling mechanisms, with the participation of the viewer. Currently available active polling mechanisms include receiving information from audience members through the telephone, with an automated response system, as described for example in U.S. Pat. No. 5,473,673, in which audience members answer coded questions which have been provided through a television set. Audience members could also send such information through a computational device connected to the Internet, for example through a menu from which selections are made. Other, more manual mechanisms for receiving active polling information include facsimiles and telephone calls in which the audience member leaves a message and/or speaks with a live operator in order to transmit the information, as well as Internet-based mechanisms such as e-mail messages and/or an electronic messaging system.

The difficulty with such active polling mechanisms is that automatic mechanisms limit the audience member to a given set of questions and answers, such as “Do you like this television program?”, or “Of these television programs, which do you prefer?” Furthermore, if the audience member is presented with a menu from which selections must be made, regardless of whether the menu is presented through the Internet, with an automated telephone response system, or even through an interactive television, the process of selection is not linked to the viewing experience of the audience member. Thus, currently available polling mechanisms cannot link the action of gathering opinions and/or preferences of the audience member with the experience of the performance itself.

### SUMMARY OF THE INVENTION

None of the disclosed background art solutions describes a mechanism for active polling of a plurality of distributed audience members which does not require such polling to occur at a predetermined time. In addition, none of the background art solutions is able to directly link the action of polling to the experience of the audience members, such that the opinion and/or preferences of the audience members can be gathered at the time that the performance is experienced by the audience members. In addition, none of the background art solutions enable the audience member to submit such opinions and/or preferences to a fully automated system for receiving and tallying such information.

Therefore, there is an unmet need for, and it would be highly useful to have, a system and a method for a completely automated mechanism for voting by audience members, in which the audience members can vote at the time of experiencing the electronically-distributed event, such as a broadcast of media content or any other appropriate type of performance.

The present invention fulfills these needs by providing a fully automated system and a method for electronic voting by an audience member at an electronically-distributed event, such that the audience member selects a choice from within the electronically-distributed event by voting with a token. The choice may optionally be one of a plurality of choices within the electronically-distributed event; for example, selecting one of a plurality of songs as the choice by voting. The choice may also optionally be a selection of the entire electronically-distributed event itself; for example, voting for a particular television program as the choice.

Preferably, the token is a unique one-time token. The token is preferably usable only within a predetermined lifespan, such that the time period for collecting the data is predefined. If the audience is to be allowed to submit more than one preference, or to have more than one “vote”, preferably a plurality of tokens are provided to the audience member. According to one embodiment, such a plurality of tokens are all preferably of equal weight, or generic. Alternatively, such tokens may optionally and preferably be classified, in which a first token is for voting for a first preference, a second token is for voting for a second preference, and so forth. In this case, the tokens are stated to be ranked and the vote is also ranked, in which ranking refers to a hierarchy of preferences, such as first place, second place and so forth.

According to a particularly preferred embodiment of the present invention, the voting mechanism is implemented through interactive television. Such an interactive television would preferably feature a voting software module for being operated by the interactive television. At the start of a voting period, the software module would preferably provide some type of visual indication to the audience member, for example through the display of text and/or an icon through the interactive television. Next, the audience member would receive at least one token, preferably from a central distribution authority. The token itself is then optionally stored at a memory of the interactive television, or alternatively is stored on a smart card or other portable memory which is in communication with the interactive television.

When the audience member wishes to vote by selecting a choice, optionally and preferably the audience member activates the voting software module for voting. The voting software module determines if one or more tokens are available to the audience member for voting. If so, the audience member indicates that a token should be submitted for voting, thereby becoming a voter. If there are a plurality of classified tokens, then the audience member must select a particular class of token according to the preferences of the audience member, for example, a first preference for the most preferred choice, a second preference for the next most preferred choice, and so forth. The token is then preferably submitted to the central voting authority. The vote thus consists of associating a token with broadcast media content through the interactive television, such that the token is “associated” with the electronically-distributed event by being used in order to select a choice from within the electronically-distributed event as previously described.

Of course, other alternative embodiments of the present invention are possible with a similar overall scheme, but implemented with different types of devices for displaying media content. Examples of these different devices include but are not limited to a radio and a computational device for displaying media content received from a network such as the Internet.

According to the present invention, there is provided a voting method for use by a voter, the method comprising: receiving a voting token, the voting token being associated with an electronically-distributed event; placing a vote with said voting token for selecting a choice associated with the electronically-distributed event, and invalidating said voting token, thereby preventing repeated use of said voting token for voting.

According to another embodiment of the present invention, there is provided a method for voting comprising: electronically receiving a voting token associated with an electronically-distributed event; associating the voting token with a choice from within said electronically-distributed event; and transmitting the voting token to a voting center and preventing reuse of the voting token.

According to yet another embodiment of the present invention, there is provided a voting method for use by a voter in a system where a voting token is received, the voting token being associated with an electronically-distributed event, the method comprising: performing both of the following: placing the vote, the vote being associated with the electronically-distributed event; and invalidating the voting token, thereby preventing repeated use of the token for voting.

According to still another embodiment of the present invention, there is provided a voting method for use by a voter, the method comprising: receiving a voting token, the voting token being associated with an electronically-distributed event; choosing a vote, the vote being associated with an electronically-distributed event; invalidating the voting token, thereby preventing repeated use of the token for voting; and transmitting the vote to a voting center, wherein the voting token is invalidated before transmission of the vote.

According to another embodiment of the present invention, there is provided a system for voting by an audience member with a vote according to an electronically-distributed event, the system comprising: (a) a central authority for distributing a token for voting to the audience member; and (b) an end user device for receiving the token from the central authority and for receiving the vote from the audience member, such that the token is returned to the central authority according to the vote of the audience member.

Hereinafter, the term “electronically-distributed event” refers to any one or more appropriate displays or units of media content. For example, according to the present invention, the term “electronically-distributed event” could optionally refer to a plurality of separate television programs, if the plurality of television programs is available as choices for voting. In this example, the electronically-distributed event comprises a plurality of sub-events, and the vote is associated with at least one, and more preferably exactly one, sub-event.

Hereinafter, the term “display” refers to any appropriate type of playback or playing out of media content data for a user, including but not limited to, the audible production of audio data and the visible production of video data, and combinations thereof.

Hereinafter, the term “network” refers to a connection between any two or more computational or other electronic devices which permits the transmission of data.

Hereinafter, the term “computational device” includes any appropriate type of digital instrument which is capable of operating a software program.

Hereinafter, the term “interactive television” refers to any appropriate device which is capable of displaying video data to a user, and which is also able to transmit input data from the user to a remote computational device. It should be noted that the video display functionality and the input data transmission functionality could optionally be implemented in two separate devices, which would then collectively be termed the interactive television.

Hereinafter, the terms “audience member”, and “viewer” are used interchangeably, it being understood that both of these terms refer to an individual who experiences broadcast media content, regardless of whether the broadcast media content includes video data, audio data or a combination thereof.

For the present invention, a software application could be written in substantially any suitable programming language, which could easily be selected by one of ordinary skill in the art. The programming language chosen should be compatible with the computational device according to which the software application is executed. Examples of suitable programming languages include, but are not limited to, C, C++, Java and Assembly.

In addition, the present invention could be implemented as software, firmware or hardware, or as a combination thereof. For any of these implementations, the functional steps performed by the method could be described as a plurality of instructions performed by a data processor.

Hereinafter, “Applied Cryptography” by Bruce Schneier, John Wiley 2nd ed. 1996, is incorporated by reference as if fully set forth herein, for the teachings regarding cryptography and techniques for implementation thereof, particularly pages 112-115 and 125-134.

### BRIEF DESCRIPTION OF THE DRAWINGS

The invention is herein described, by way of example only, with reference to the accompanying drawings, wherein:

FIG. 1 is a schematic block diagram of a first exemplary system according to the present invention;

FIG. 2 is a schematic block diagram of a second exemplary system according to the present invention; and

FIG. 3 is a flowchart of an exemplary method according to the present invention.

### DESCRIPTION OF THE PREFERRED EMBODIMENTS

The present invention is of a fully automated system and a method for electronic voting by an audience member at an electronically-distributed event, such as a broadcast of media content, or any other appropriate type of performance. The audience member can therefore also be designated as the “voter” according to the present invention. The audience member selects a choice from within the electronically-distributed event by voting with a token. The choice may optionally be one of a plurality of choices within the electronically-distributed event; for example, selecting one of a plurality of songs as the choice by voting. The choice may also optionally be a selection of the entire electronically-distributed event itself; for example, voting for a particular television program as the choice. Thus, the token is “associated” with the electronically-distributed event by being used in order to select a choice from within the electronically-distributed event, either as one of a plurality of choices within the electronically-distributed event, or even as the entire electronically-distributed event.

The voting may therefore be viewed as covering a set of possible vote-able options, as defined within the voting token: for example, the set of all songs played on a specific channel during one program on one day; the set of all songs played on a specific channel between a specific end time and a specific beginning time; the set of all programs played on any channel between a specific end time and a specific beginning time, and so forth. All such sets can be viewed as answering a particular question, such as “What is your favorite song today?” or “Which program would you not want your children to watch?”

Preferably, the token is a unique one-time token. The token is preferably usable only within a predetermined lifespan, such that the time period for collecting the data is predefined. If the audience is to be allowed to submit more than one preference, or to have more than one “vote”, preferably a plurality of tokens are provided to the audience member. According to one embodiment, such a plurality of tokens are all preferably of equal weight, or generic. Alternatively, such tokens may optionally and preferably be classified, in which a first token is for voting for a first preference, a second token is for voting for a second preference, and so forth.

According to a particularly preferred embodiment of the present invention, the voting mechanism is implemented through an end user device for displaying media content, a particularly preferred, but non-limiting, example of which is interactive television. Such an interactive television would preferably feature a voting software module for being operated by the interactive television. At the start of a voting period, the software module would preferably provide some type of visual indication to the audience member, for example through the display of text and/or an icon through the interactive television. Next, the audience member would receive at least one token, preferably from a central distribution authority. Optionally, the token(s) are delivered automatically to the interactive television device at the start of the voting period. Alternatively, the token(s) are only delivered upon request of the audience member. The token itself is then optionally stored at a memory of the interactive television, or alternatively is stored on a smart card or other portable memory which is in communication with the interactive television.

When the audience member wishes to vote, optionally and preferably the audience member activates the voting software module for voting. The voting software module determines if one or more tokens are available to the audience member for voting. In addition, the voting software module also preferably determines whether the time period for voting is still running, such that voting is still allowed. The information regarding such a time period is more preferably transmitted to the interactive television device with the token or tokens.

If these conditions are fulfilled, the audience member indicates that a token should be submitted for voting according to a choice which is associated with the electronically-distributed event. If there are a plurality of classified tokens, then the audience member must select a particular class of token according to one or more preferences, for example, a first preference, a second preference, and so forth. The token is then preferably submitted to the central voting authority. The vote thus consists of associating a token with broadcast media content through the interactive television, optionally also according to a specific preference of the audience member for classified tokens.

However, optionally and more preferably, the selection of the audience member, and hence the vote itself, is not limited to a predetermined finite set of choices. For example, the choices which are associated with the electronically-distributed event may optionally only be determined at the time of the event, such as the time of broadcast of media content. Indeed, these choices may even be determined in “real time”, such that the availability of a particular selection for voting is only known during the event, as for a broadcast of songs in which the audience members select the songs to be played during the broadcast event itself. If the choices are not predetermined, then preferably the interactive television or other end user device displays a “vote now” icon or other immediate indication of the availability of a particular choice, such that the end user device does not need to receive a predetermined list of choices before the voting process occurs.

Optionally, the transmission of the vote, and hence the voting mechanism, can be personalized and secured by using any appropriate type of standard interactive television authentication scheme, such as the “Value@TV™” scheme (NDS Limited, United Kingdom). Such a scheme preferably encrypts the token and/or causes the token to be transmitted through a secure channel.

Also optionally and preferably, the electronically-distributed event with which the vote is associated is identified with an identifier, which is more preferably secured with encryption or another security mechanism. Examples of suitable identifiers include but are not limited to an identifier provided with the event itself, such as an identifier obtained from the EPG (electronic program guide) information stream for a television program; a special identifier transmitted for the purposes of voting and therefore related to the event as a whole or to any segment thereof to which voting is applicable; and a time stamp.

Of course, other alternative embodiments of the present invention are possible with a similar overall scheme, but implemented with different types of end user devices for displaying media content. Examples of these different devices include but are not limited to a radio and a computational device for displaying media content received from a network such as the Internet, as well as any other appropriate type of end user device associated with an electronically-distributed event.

The preferred combination of hardware and software components enables the present invention to most effectively protect the voting mechanism, while still enabling the audience member to easily and transparently vote with the token. More preferably, the interactive television or other end user device which is used for the present invention includes a renewable security module, such as a smart card for example. The renewable security module is itself preferably secured, such that information contained within this module is protected from unauthorized access. The security module receives the encrypted token. Most preferably, the operation of the security module is transparent or substantially transparent to the end user.

The end user device is preferably in communication with the network control center through a network, which could be the Internet for example, but which could also be a cable network and/or satellite communication, for example. Other options for communication with the network control center include, but are not limited to, communication through the PSTN (public switched telephony network) and/or wireless communication devices, such as cellular telephones for example. Furthermore, also optionally, two separate modes of communication could also be used, one such mode for the forward path (communication from the network control center to the end user device) and a different communication mode for the return path (communication from the end user device to the network control center). Alternatively, the end user device is in communication with the network control center indirectly, for example through the use of a portable storage medium such as a CD-ROM for example, which could optionally be sent to the end user for distribution of content and/or codes, for example.

The principles and operation of the present invention may be better understood with reference to the drawings and the accompanying description.

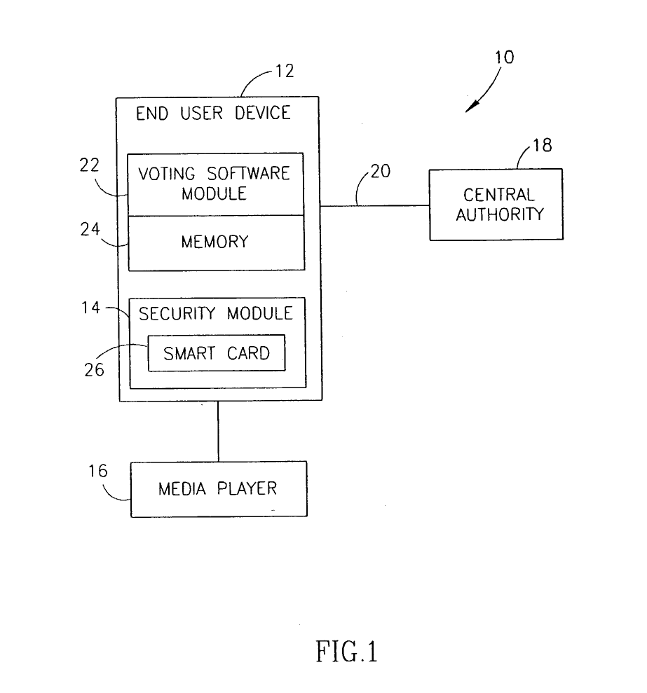

Referring now to the drawings, FIG. 1 is a schematic block diagram of a system according to the present invention for automated voting by an audience member. Although the system is described with regard to implementation with interactive television, it is understood that this is for the purposes of illustration only and is without any intention of being limiting in any way.

As shown, a system 10 features an end user device 12 with an associated security module 14. End user device 12 also features a media player 16 for playing back or otherwise displaying at least one type of media content, such as audio content for example. The media content is associated with an electronically-distributed event, such as the broadcast of a television program, for example. For the purposes of explanation only and without any intention of being limiting, media player 16 is preferably an interactive television.

End user device 12 is preferably also in communication with a central authority 18 through a network 20. Network 20 could be substantially any appropriate type of suitable network, including but not limited to, PSTN (public switched telephony network), wireless networks (such as those for cellular telephones, for example), the Internet, a cable network or a satellite distribution mechanism. For the purposes of description, central authority 18 is only required to handle functionality related to voting by the audience member, or user, through end user device 12. Optionally, central authority 18 may also control broadcasts of media content to end user device 12, although alternatively such broadcasts may be handled by a different component of system 10 (not shown).

When a voting period has started, a voting software module 22 is launched by end user device 12 for performing actions related to voting with the audience member. Voting software module 22 may optionally receive a signal from central authority 18 to initiate operations at the start of the voting period, or alternatively may be launched at the request of the audience member. Also alternatively, such voting periods may be scheduled in advance with voting software module 22 by central authority 18.

Once voting software module 22 is operating, voting software module 22 preferably receives one or more tokens from central authority 18, either automatically or alternatively at the request of the audience member. Optionally, each token is a unique single use token for a single vote, such that the audience member is only able to submit a single token for selecting a choice in order to vote in connection to any particular broadcast event, such as the selection of a favorite song, for example. Alternatively and more preferably, each token is a unique single use token, but a plurality of classified tokens are given to the audience member for any voting event, such that the audience member is able to express a plurality of ranked preferences by selecting a plurality of choices. For example, a first token would be used for the first preference, or most preferred choice, of the audience member, a second token for the second preference, and so forth.

The token(s) are optionally transmitted through the same medium as the electronically-distributed event with which they are associated, such that both the broadcast media content and the tokens are transmitted through network 20. Alternatively, the tokens are transmitted through a different medium than the broadcast media content.

These transmitted token(s) are optionally stored at a memory 24 of end user device 12, or alternatively are stored on a smart card 26 or other portable memory which is in communication with end user device 12. More preferably, as shown, smart card 26 is removably operatively associated with security module 14.

When the audience member wishes to vote, optionally and preferably the audience member activates voting software module 22 for voting. Voting software module 22 determines if one or more tokens are available to the audience member for voting. In addition, voting software module 22 also preferably determines whether the time period for voting is still running, such that voting is still allowed. Optionally and more preferably, voting software module 22 also determines whether the vote applies to the currently displayed electronically-distributed event, such as the currently displayed television program. This issue may be important since some votes may optionally be usable across a range of channels for distribution of such events, and/or for multiple such events, while votes may optionally only be applicable in the context of a particular electronically-distributed event, for example. Furthermore, a vote may also optionally be submitted for an interactive application. The information regarding such a time period is more preferably transmitted to end user device 12 with the token or tokens.

If these conditions are fulfilled, the audience member indicates that a token should be submitted for voting. If there are a plurality of classified tokens, then the audience member must select a particular class of token according to the preferences of the audience member, for example, a first preference for a first or most preferred choice, a second preference for the second or next most preferred choice, and so forth. Preferably, only available classes of tokens are shown as being available for voting through voting software module 22. The token is then preferably submitted to central authority 18. The vote thus consists of associating a token with broadcast media content through end user device 12, optionally also according to a specific preference of the audience member for classified tokens.

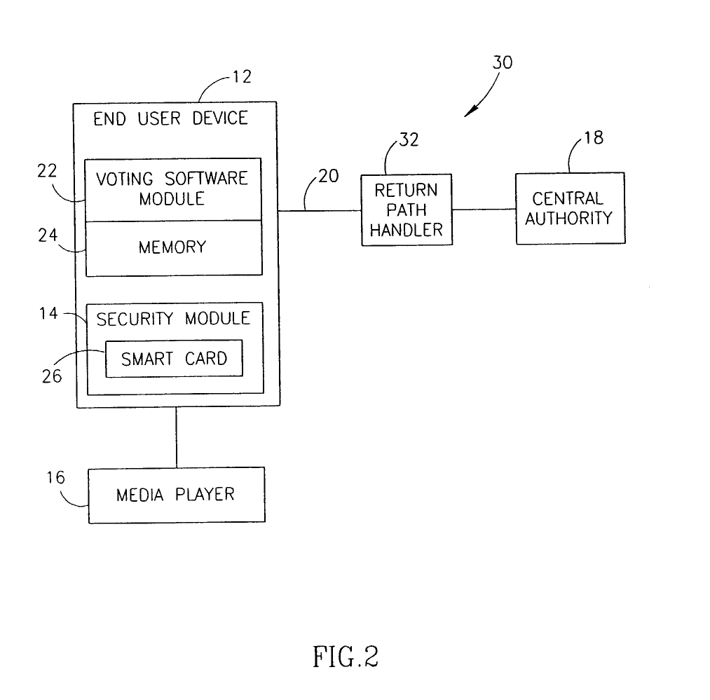

FIG. 2 is a block diagram of a second exemplary system according to the present invention, with added security and privacy protection functions. As shown, a system 30 features a number of the same components as FIG. 1, which are identically numbered to indicate similar or identical functions. In addition, system 30 features a return path handler 32 as shown, which is in communication with end user device 12 and central authority 18, and which is preferably connected to both end user device 12 and central authority 18 through network 20. The addition of return path handler 32 protects the privacy of the audience member by preventing central authority 18 from associating the action of voting with the token with a particular, identified user, as described in greater detail below. Additional protection is preferably provided through encryption of the token itself, also as described in greater detail below.

The operation of system 30 is preferably performed as follows. First, central authority 18 preferably issues encrypted tokens to end user device 12. These encrypted tokens are optionally and more preferably associated with an application identifier. The application identifier most preferably contains sufficient information for enabling voting software module 22 to determine the time period during which voting is permitted, and/or to display information about the particular voting event to the audience member. For example, voting software module 22 should preferably be able to display information about the rules for voting, as well as information about the particular broadcast event or events, and/or the particular media content, for which the voting process is being conducted. Voting software module 22 is therefore preferably able to decrypt at least a portion of the token, for example according to a public key encryption mechanism. Optionally, only a portion of the token is decrypted, while at least a portion of the token is not decrypted. The portion of the token which is not decrypted is then optionally and more preferably returned to central authority 18 as a validity proof.

In addition, central authority 18 optionally and preferably issues an encrypted item identifier, which voting software module 22 also preferably associates with a particular item for display to the audience member. Examples of suitable identifiers include but are not limited to an identifier provided with the event itself, such as an identifier obtained from the EPG (electronic program guide) information stream for a television program; a special identifier transmitted for the purposes of voting and therefore related to the event as a whole or to any segment thereof to which voting is applicable; and a time stamp. Indeed, this particular aspect of the embodiment of FIG. 2 may also optionally and preferably be implemented with the embodiment of FIG. 1, in order to specifically associate the vote with a particular electronically-distributed event, such as a particular television program for example. The identifier is thus useful for secure identification of the proper association between the vote and the electronically-distributed event for which the vote is intended. Of course any appropriate type of security mechanism could optionally be used, including but not limited to encryption.

For example, if the audience member is to select a favorite song or television program, the item identifier identifies that particular song or television program for which the audience member has voted. This step is necessary in order to prevent return path handler 32 from determining how the audience member voted. In other words, return path handler 32 is preferably able to determine whether the audience member voted (if a vote was previously submitted for an item), but is not able to identify the specific item since the item identifier is encrypted.

Voting software module 22 of end user device 12, or alternatively some other component of end user device 12 (not shown), then receives the vote from the audience member. Voting software module 22, or this other component, then preferably makes a vote transaction message which includes the encrypted token and associated application identifier, as well as the encrypted item identifier. The vote transaction message is then signed by using, any appropriate method which enables return path handler 32 to determine that vote transaction message is in fact a valid, authenticated message from that particular audience member. For example, a private key scheme could optionally be used in order to guarantee the identity of the voting audience member.

Return path handler 32 then preferably tracks which audience members have voted on any particular voting event, but is unable to determine the nature or outcome of the vote. Rather, return path handler 32 is preferably only able to determine whether a vote is received. This limited ability to determine whether an audience member has voted is sufficient to prevent unauthorized multiple votes for a single voting event by a single audience member, but also protects the privacy of the audience member. Assuming that the vote is valid, return path handler 32 preferably removes any information for specifically identifying the audience member from the vote transaction message, and then forwards the remainder of the vote transaction message, including the encrypted token and the encrypted item identifier, to central authority 18. Optionally, general identification information for the audience member, which is useful for statistical purposes for example, is forwarded with the vote transaction message. Thus, information related to the specific identity of the viewer is preferably not sent to central authority 18, although as previously noted, optionally general information about the viewer is returned to central authority 18.

Central authority 18 then preferably decrypts the token and the item identifier. More preferably, the vote is recorded if the vote is determined to be valid, for example, if the token itself is determined to be a valid token. Most preferably, the validity of the voting process is further protected by causing a token to be removed from end user device 12, or otherwise marked as unavailable by voting software module 22, to prevent the audience member from attempting to perform an invalid action.

Optionally and more preferably, the connection between return path handler 32 and central authority 18, for example through network 20, is secure. Various security mechanisms are known in the art and could be implemented, such as SSL (secure socket layer) or TLS (transport layer security) for secure communication through a network such as the Internet, for example. Another optional security mechanism which is suitable for use with the present invention is the Data Over Cable Service Interface Specification (DOCSIS), which is a cable standard for encryption to protect the digital transmissions on cable. Other security mechanisms which are suitable for other types of communication networks may also be used, such as security mechanisms for transfer over the PSTN (public switched telephony network) and/or over wireless networks.

Optionally, voting software module 22 may wait until all tokens associated with a particular voting event have been used before submitting these tokens to return path handler 32, for example if the audience member must rank a plurality of preferences with a plurality of classified tokens. Alternatively, each token may be submitted separately to return path handler 32, and hence to central authority 18, which enables real-time updates to be performed for the voting process. This latter implementation is possible with storage at any appropriate location within system 30, as long as each vote is registered permanently. Also, optionally with this implementation, the votes are stored locally at return path handler 32 and are then submitted at particular times, for example according to preallocated timeslots and/or random submission times in order to avoid overloading central authority 18.

Also optionally and alternatively, votes for each audience member are preferably stored at end user device 12, for example at memory 24 and/or smart card 26. Voting software module 22 would then submit all votes from each audience member at one time to return path handler 32, more preferably at a predetermined time for reporting these votes. Most preferably, the predetermined time would be allocated differently to different end user devices 12 in order to avoid overwhelming return path handler 32 and/or central authority 18.

According to preferred implementations of the present invention, the audience member is at least able to view those voting events for which the audience member has voted, and also the vote that was cast in each instance. Preferably the audience member is also able to change one or more votes which have already been cast. Optionally, such information is provided through voting software module 22, such that preferably the vote(s) are stored at end user device 12. Optionally and alternatively, both the information about votes which have been cast and the ability to change such votes are optionally provided through return path handler 32 and/or central authority 18. For example, either of return path handler 32 and/or central authority 18 could optionally return the encrypted vote transaction message to end user device 12, which would then decrypt and display the information to the audience member. More preferably, end user device 12, and more specifically voting software module 22, would also receive one or more token(s), in order for the audience member to be able to change the vote. Alternatively, voting software module 22 could receive a message indicating that the token is to be considered as though it had been returned, such that the token is again available to the audience member for voting.

However, such an ability to “return” a vote which was already cast is more preferably provided through return path handler 32 rather than central authority 18, since return path handler 32 preferably knows the identity of the audience member, while central authority 18 preferably does not know the identity of the audience member, as previously described. Also, the ability to change a vote which has already been cast is clearly more complicated once the vote has been registered with central authority 18, particularly in the preferred implementation in which central authority 18 does not know the identity of the audience member. For this preferred implementation, a separate list of audience member identities, or at least addressing information for end user devices 12 through network 20, would need to be kept at a secure location, linked to some type of vote identifier for each vote which has been cast. This type of list is contrary to the preferred implementation, previously described, which attempts to protect the privacy of each audience member by maintaining anonymity of each vote. Alternatively, each vote transaction message would need to be stored at return path handler 32, for later retrieval in the case of a changed vote.

According to another optional, alternative embodiment for changing votes of the audience member, if the voting period has not ended, such that the audience member could still submit a token to central authority 18 if such a token is available through end user device 12, the audience member is permitted to repeatedly submit a different token for voting as long as the voting period has not ended. Each new, different token then replaces the previously received token for “generic” (single vote) tokens. For classified tokens, in which the audience member expresses a plurality of different preferences by submitting a plurality of tokens, the submission of a new token for the same voting event preferably causes previously submitted tokens to be registered at a lower level of preference, such that the lowest level preference token is discarded as a vote. Optionally and alternatively, each vote at a particular level by submitting a token having a particular level of preference replaces the previous vote with that level of preference token.

After the voting period has ended, optionally and preferably the results are reported to audience members, for example through a display at end user device 12. The display may optionally be incorporated into the event of broadcasting media content for which the voting process has been performed, or alternatively may optionally be displayed through the user interface provided by voting software module 22.

Alternatively, if the act of voting is encouraged through the provision of loyalty points or other benefits to the audience member, optionally the results may not be reported. For example, if the voting process is intended as part of a “test marketing” campaign for a proposed television program, the results may not be reported to the audience members, who may instead be rewarded in some other manner for their participation. The benefit could also optionally be provided to the audience member as part of a contest, for example to reward the audience member or members who vote the most frequently. Further examples of suitable rewards and/or benefits are disclosed in granted United Kingdom Patent No. GB 2326004 and in corresponding U.S. patent application Ser. No. 09/089,717, which are hereby incorporated by reference as if fully set forth herein. These loyalty points or other benefit could optionally be provided automatically through return path handler 32, which could for example be in contact with another component of system 30 for recording such a benefit for the audience member (not shown). Since return path handler 32 is already aware of the identity of the audience member, providing such a reward through communication with return path handler 32 is preferred.

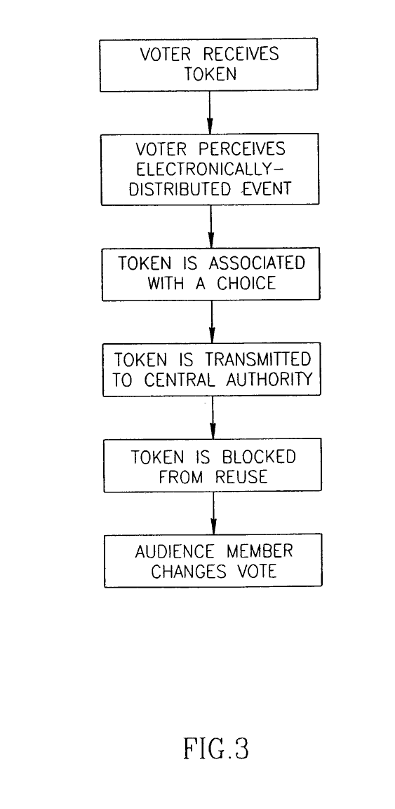

FIG. 3 is a flowchart of an exemplary method according to the present invention for voting with a token.

As shown, the audience member or voter first receives a voting token which is associated with an electronically-distributed event. The voting token and the electronically-distributed event may optionally be distributed through the same medium, or alternatively may be distributed through different media. In either case, both the voting token and the electronically-distributed event are preferably received by one or more end user devices. Next, the voting token is associated with a choice, which is itself associated with the electronically-distributed event and which is then expressed as the vote of the audience member.

Once the token has been associated with a choice, such that the token is associated with the vote of the audience member, the voting token is transmitted to a central authority, such as a voting center for example. Next, preferably the token is somehow prevented from being reused. For example, if the token is received by an end user device, the end user device preferably either marks the token as being used and hence unavailable, or alternatively deletes the token itself from a memory of the end user device.

Optionally, the audience member is allowed to change a vote, for example by replacing the token with a new token, or alternatively by retrieving the token and previous associated vote, and submitting the token with a new associated vote.

While the invention has been described with respect to a limited number of embodiments, it will be appreciated that many variations, modifications and other applications of the invention may be made.

What is claimed is:

1. A voting method for use by a voter, the method comprising:
receiving a voting token, the voting token being associated with an electronically-distributed event;
placing a vote with said voting token for selecting a choice associated with said electronically-distributed event; and
invalidating said voting token, thereby preventing repeated use of said voting token for voting.

2. The voting method according to claim 1 and also comprising:
securely storing said voting token.

3. The voting method according to any of the above claims and also comprising:
requesting receipt of said voting token by the voter.

4. The voting method according to any of the above claims and wherein the electronically-distributed event comprises offering said voting token to the voter, and wherein said voting token is received in response to a result of offering said voting token.

5. The voting method according to either of claims 1 or 2 and wherein said voting token is received without a prior request by the voter.

6. The voting method according to any of the above claims and also comprising:
allowing the voter to prevent reception of said voting tokens.

7. The voting method according to any of the above claims and wherein the electronically-distributed event comprises a plurality of sub-events, and the vote is associated with exactly one sub-event.

8. The voting method according to any of the above claims and wherein said voting token comprises exactly one token and the receiving step is executed only once for a given voter.

9. The voting method according to claim 1 and wherein the event is associated with a time period and the voting occurs at a voting time during the time period.

10. The voting method according to claim 9 and wherein the voting time is chosen by a voter.

11. The voting method according to claim 9 and wherein the voting time is determined other than by the voter.

12. The voting method according to any of the above claims and also including:
transmitting the vote to a voting center.

13. The voting method according to any of the above claims and wherein the vote includes voter identification information.

14. The voting method according to any of claims 1-12 and wherein the vote is anonymous.

15. The voting method according to any of claims 1-12, wherein the vote initially includes voter identification information, including at least partial information for specifically identifying the voter, and wherein at least said partial information for specifically identifying the voter is removed.

16. The voting method according to any of the above claims and wherein the vote is not limited to at least one choice being predetermined before distribution of said electronically-distributed event.

17. The voting method according to any of claims 1-15 and wherein the vote is associated with a multiple-choice question, such that said choice is an answer to said multiple-choice question.

18. The voting method according to any of claims 1-16 and wherein the vote is not associated with a multiple-choice question.

19. The voting method according to any of the above claims and wherein placing said vote comprises associating said voting token with a choice.

20. A method for voting comprising:
electronically receiving a voting token associated with an electronically-distributed event;
associating said voting token with a choice from within said electronically-distributed event; and
transmitting said voting token to a voting center and preventing reuse of said voting token.

21. A voting method for use by a voter in a system where a voting token is received, said voting token being associated with an electronically-distributed event, the method comprising:
performing both of the following:
placing the vote, the vote being associated with the electronically-distributed event; and
invalidating said voting token, thereby preventing repeated use of the token for voting.

22. A voting method for use by a voter, the method comprising:
receiving a voting token, said voting token being associated with an electronically-distributed event;
choosing a vote, the vote being associated with a choice from within an electronically-distributed event;
invalidating said voting token, thereby preventing repeated use of the token for voting; and
transmitting the vote to a voting center, wherein said voting token is invalidated before transmission of the vote.

23. The voting method according to claim 22 and also comprising changing the vote, wherein the changing occurs after the choosing and before the transmitting.

24. The voting method according to claim 22 or claim 23 and wherein the transmitting occurs at approximately a predetermined time.

25. The voting method according to any of claims 22-24 and also comprising:
requesting a new voting token; and
repeating at least the receiving, choosing, invalidating and transmitting steps.

26. The voting method according to claim 25 and wherein the requesting comprises:
transmitting the invalidated voting token to the voting center and requesting cancellation of the vote associated with the invalidated token in exchange for a new voting token.

27. The voting method according to any of the above claims and also comprising:
providing a benefit to the voter based, at least in part, on the voter having voted.

28. The voting method according to claim 27 and wherein the providing is also based, at least in part, on the vote of the voter.

29. A voting method for use by a voter, the method comprising:
receiving a plurality of voting tokens, the plurality of voting tokens being associated with an electronically-distributed event; and
selecting one voting token as a selected voting token from the plurality of voting tokens and performing both of the following for the selected voting token;
placing a vote, the vote being associated with a choice from the electronically distributed event; and
invalidating the selected voting token, thereby preventing repeated use of the token for voting.

30. The voting method according to claim 29 and wherein the plurality of voting tokens comprises a predetermined number of voting tokens, each voter of a multiplicity of voters receiving the same number of voting tokens.

31. The voting method according to claim 29 and wherein the plurality of voting tokens comprises a variable number of voting tokens, each voter of a multiplicity of voters receiving a number of voting tokens determined in accordance with voter characteristics.

32. The voting method according to any of claims 29-31 and wherein each voting token is associated with a type of vote.

33. The voting method according to claim 32 and wherein each of the plurality of voting tokens is associated with the same type of vote.

34. The voting method according to claim 32 and wherein at least a first one of the plurality of voting tokens is associated with a different type of vote than at least a second one of the plurality of voting tokens.

35. The voting method according to any of claims 32-34 and wherein the type of vote comprises an indication of rank.

36. The voting method according to any of claims 32-35 and also comprising:
altering the type of vote associated with at least one of the plurality of voting tokens.

37. The voting method according to claim 36 and wherein the altering occurs after the placing.

38. A voting method for use by a voter, the method comprising:
receiving a voting token, said voting token being associated with an electronically-distributed event; and
placing a vote, the vote being associated with the electronically-distributed event;
wherein the vote is not limited to a predetermined finite set of choices.

39. The method according to claim 38 and wherein the electronically-distributed event comprises a first plurality of sub-events.

40. The method according to either of claims 37 or 38 and wherein the vote is limited to a second plurality of choices which is not predetermined.

41. The method according to claim 38, wherein said vote features an identifier for associating said identifier with the electronically-distributed event, such that placing said vote includes transmitting said identifier for identifying said associated electronically-distributed event.

42. The method according to claim 41, wherein said identifier is secured.

43. The method according to claim 42, wherein said identifier is encrypted.

44. A system for voting by an audience member with a vote according to an electronically-distributed event, the system comprising:
(a) a central authority for distributing a token for voting to the audience member; and
(b) an end user device for receiving said token from said central authority and for receiving the vote from the audience member, such that said token is returned to said central authority according to the vote of the audience member.

45. The system of claim 44, wherein said end user device further comprises a media player for displaying the electronically-distributed event.

46. The system of claim 45, wherein the electronically-distributed event is distributed through a first medium and said token is distributed through a second medium, such that said first medium is different from said second medium.

47. The system of claim 45, wherein the electronically-distributed event and said token are distributed through the same medium.

48. The system of any of claims 44-47, wherein said end user device further comprises a voting software module for receiving said token from said central authority and for associating the vote of the audience member with said token, such that transmitting said token to said central authority also transmits the vote of the audience member.

49. The system of claim 48, wherein said token is sent from said central authority as an encrypted token and said voting software module decrypts at least a portion of said encrypted token.

50. The system of claim 49, wherein a portion of said encrypted token remains encrypted, for being returned as a proof of validity to said central authority.

51. The system of claims 49 or 50, wherein at least said portion of said encrypted token is encrypted according to public key encryption.

52. The system of any of claims 49-51, wherein said end user device and said central authority are connected by a secure channel.

53. The system of any of claims 48-52, further comprising a network for connecting said end user device and said central authority, such that said secure channel is implemented within said network.

54. The system of any of claims 48-53, wherein said voting software module causes said end user device to display a user interface, and wherein the audience member submits the vote through said user interface.

55. The system of claim 54, wherein said token is only valid for a predetermined period of time.

56. The system of claim 55, wherein the audience member is alerted to said predetermined period of time through a display of an icon by said user interface.

57. The system of any of claims 48-54, wherein said token is only valid for a predetermined period of time and the audience member is alerted to said predetermined period of time through a display of an icon by said end user interface.

58. The system of any of claims 48-57, further comprising a return path handler for receiving a vote transaction message from said end user device, said vote transaction message comprising an identifier for the audience member and said token associated with the vote of the audience member, said return path handler removing said identifier for the audience member such that the vote is anonymous.

59. The system of any of claims 48-57, further comprising a return path handler for receiving a vote transaction message from said end user device, said vote transaction message including at least partial information for specifically identifying the voter and an identifier for said token associated with the vote of the audience member, said return path handler removing at least said partial information for specifically identifying the voter.

60. The system of any of claims 48-59, wherein said voting software module prevents said token from being used again after the audience member submits the vote, such that said token is only used once.

61. The system of any of claims 44-60, further comprising a media player for displaying the electronically-distributed event to the audience member, said media player being selected from the group consisting of a television, a radio and a computational device.

62. The system of claim 61, wherein said media player is a computational device connected to said central authority through the Internet.

63. The system of any of claims 44-62, wherein the vote is anonymous.
